(19) United States
(12) Patent Application Publication
(10) Pub. No.: US 2006/0144499 A1
(43) Pub. Date: Jul. 6, 2006

(54) Method and apparatus for producing gloves and boots with a liquid inner coating

(76) Inventor: John J. Brogan, Frenchtown, NJ (US)

Correspondence Address: SYNNESTVEDT LECHNER & WOODBRIDGE LLP, P O BOX 592, PRINCETON, NJ, 08542-0592, US

(21) Appl. No.: 11/288,850

(22) Filed: Nov. 29, 2005

Related U.S. Application Data
(60) Provisional application No. 60/632,298, filed on Dec. 1, 2004.

(51) Int. Cl. B32B 37/00; B29C 65/00; B29C 65/08

(52) U.S. Cl. 156/73.1

(57) ABSTRACT

A method produces gloves and boots having a liquid inner coating that does not interfere with the seams. Initially, a first plastic web, which could be plastic like polyethylene or plastic laminated with an outer surface such as a cloth, is treated by electroshock to make it receptive to lotion. The web then mergers with a paper backer and lotion is applied by a silk screen station within the glove or boot but not in the seam area. A second plastic web then mergers with the first plastic web and proceeds to a welding unit which produces seams in the form of the glove or boot but outside of the lotion area. Excess plastic webbing is then removed, the paper backer is cut to length, and the final product is formed.

### CROSS REFERENCE TO RELATED APPLICATIONS

This application claims the priority of provisional U.S. application Ser. No. 60/632,298 filed on Dec. 1, 2004 and entitled “Description of Method Process for Producing Liquid Inner Coating of Plastic Gloves and Boots, et al.” by John J. Brogan, the entire contents and substance of which are hereby incorporated in total by reference.

### BACKGROUND OF THE INVENTION

1. Field of the Invention

The invention relates to a method and apparatus for producing gloves or boots having an inner surface pre-coated with materials beneficial to the human skin.

2. Background of the Invention

There are two known ways of applying lotion to the hand or foot through the use of a glove or boot. The first method is to put the lotion inside the glove or boot after the glove or boot is formed. This is a messy and inefficient solution. The second method is to spread lotion or medication or the like over the entire width of a webbing and then to form seams with a second webbing in the shape of a glove or boot. This second approach is not only wasteful of lotion and/or medication, but also may produce poor edge seams resulting in breaking, etc.

It was in the context of the foregoing prior art that the present invention arose.

### SUMMARY OF THE INVENTION

Briefly described the invention comprises a method and apparatus for producing gloves or boots having lotion and/or medication on the inside. Initially a first web of plastic material is drawn off a roll and proceeds under a unit that exposes it to an electrical shock in the neighborhood of 90 dynes. This treatment allows the surface of the plastic to accept a serum coating such as lotion or medication. The first, or bottom, web is then merged with a paper backing and introduced into a silk screen chemical application unit. The silk screen unit applies the lotion or medication to the glove but just inside the area where the seams would be formed. The first, or bottom, web with the paper backing, then proceeds to a merge station where it is combined with a top, or second, plastic web and, from there, advances to the welding unit. In the welding unit hot seams are produced using a die heated to approximately 290° C. which produces the outline of the glove or boot. There is a definable gap between the lotion coated portion of the first, or bottom, web and the seams. The sandwiched materials then advance out of the seam welding unit and the excess webbing from the first and second plastic webs are removed and the sections cut up so that the only thing remaining is the plastic glove, with lotion inside, still attached to a paper backer.

The invention may be more fully understood by reference to the following drawings.

### BRIEF DESCRIPTION OF THE DRAWINGS

FIG. 1A is a top plan view of the preferred embodiment of the invention showing a two-ply plastic glove, having lotion or medication on the inside, attached to a piece of backing paper.

FIG. 1B is a cross-sectional view of the glove shown in FIG. 1A from perspective 1B-1B and illustrating the manner in which the medication or lotion is deposited on the inside of the glove.

FIG. 2A is a top plan view of a plastic boot, having lotion or medication on the inside, produced by the method of the preferred embodiment of the invention.

FIG. 2B is a cross-sectional view of the boot shown in FIG. 2A from perspective 2B-2B and also illustrating the manner in which lotion or medication is deposited on the inside of the boot.

FIG. 3 illustrates the preferred method and apparatus for forming a medicated glove.

FIG. 4 illustrates the preferred method and apparatus for forming a boot having medication on the inside thereof.

### DETAILED DESCRIPTION OF THE PREFERRED EMBODIMENT

During the course of this description like numbers will be used to identify like elements according to the different views that illustrate the invention.

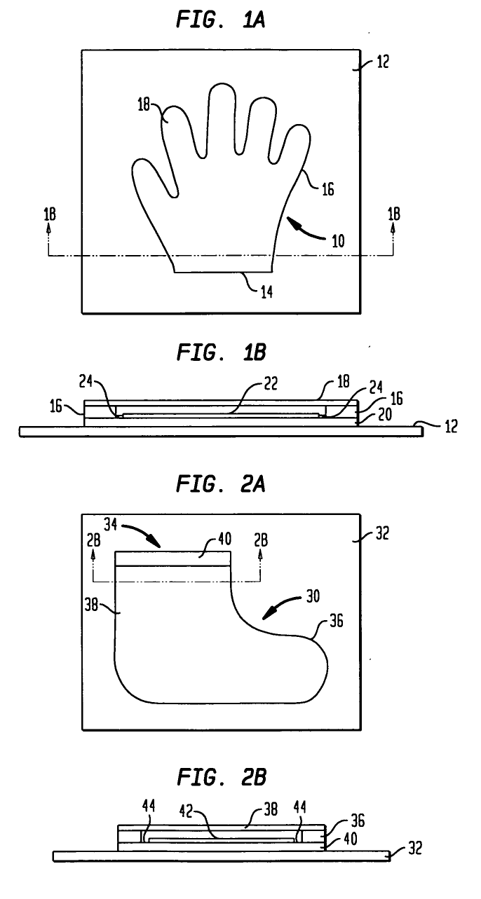

A glove 10, manufactured according to the preferred embodiment of the invention, is illustrated in FIG. 1A. Glove 10 is shown attached to a section of paper backing web 12. Opening 14 permits the user to insert his or her hand into the glove 10 and then pull it off of the backing paper 12. Glove 10 is releasable attached to backing paper 12 at seams 16.

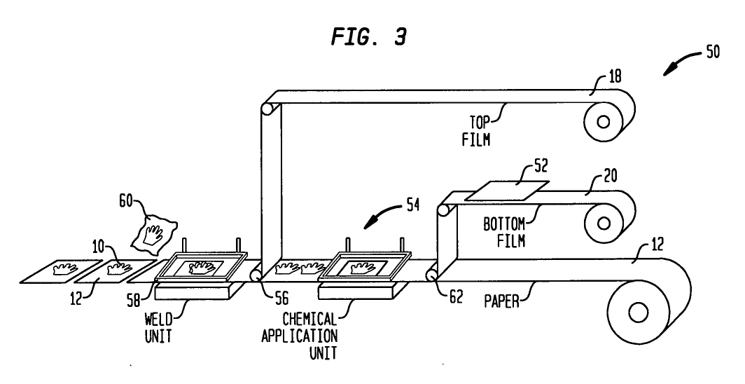

FIG. 1B is a cross-sectional detail of the glove 10 illustrated in FIG. 1A as seen from perspective 1B-1B. Glove 10 comprises a bottom, or first plastic web 20, attached by seams 16 to a top, or second plastic web 18. Lotion, or medication 22 is located on the top surface of the bottom, or first plastic web layer 20, and separated by a gap 24 from the seams 16. It is evident from FIG. 1B that the lotion 22 is pre-applied to the bottom layer 20 in such a fashion that it does not interfere with the hot-melt seams 16. The glove 10 illustrated in FIGS. 1A and 1B is manufactured according to the preferred embodiment of the invention illustrated in FIG. 3.

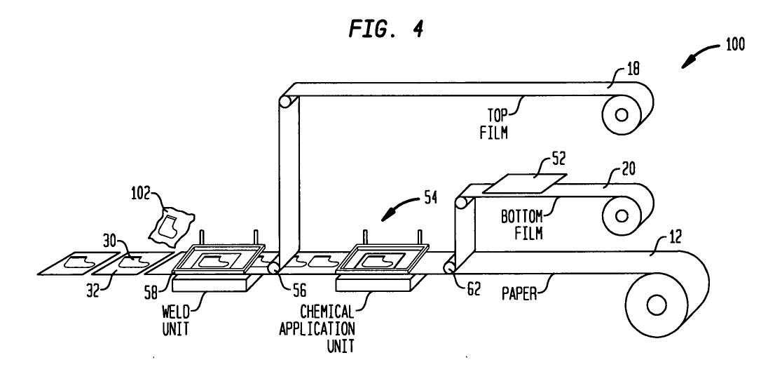

FIG. 2A illustrates a boot 30, having a structure similar to that of glove 10 illustrated in FIGS. 1A and 1B above, but manufactured according to the preferred embodiment of the invention as illustrated in FIG. 4. Boot 30 is releasable carried on backing paper 32 and includes an opening 34 into which a foot can be inserted. A seam 36 defines the outer periphery of the boot 30. Boot 30 includes a bottom, or first plastic web layer 40, and a top, or second, plastic web layer 38 connected to the bottom layer of 40 by seam 36.

FIG. 2B is a cross-sectional detail of the boot 30 shown in FIG. 2A from the perspective 2B-2B. Like glove 10, the boot 30, comprises a sandwich of materials including the backing paper layer 32, the first, or bottom layer 40, seam 36 and top, or second layer 38. Shown inside the cavity of the boot 30 is a layer of lotion or medication 42 which is deposited on the first, or bottom layer 40. A gap 44 exists between the layer of lotion 42 and the side seams 36. Gap 44 guarantees that the lotion 42 does not get into the hot melt seams 36 and also insures that only the right amount of lotion 42 is applied and none is wasted.

FIG. 3 illustrates the preferred method 50 for forming a glove 10 such as illustrated in FIGS. 1A and 1B. The steps of the method are generally as follows. A first or bottom web of plastic film material 20 is dispensed from a roller and passes under an electrical shock device 52 that exposes the surface of the bottom sheet 20 to a shock of 90 dynes. This treatment allows the surface of the plastic 20 to accept the lotion or serum coating 22. The pre-treated bottom layer 20 is then merged with the paper backing stock 12 at roller 62 and introduced into the chemical application unit 54. Chemical application unit 54 comprises a common silk screen unit. The silk screen unit 54 applies lotion or medicated material 22 in the shape of glove 10 but in a size that is smaller than the space between the seams 16. The bottom layer 20 and the paper backer 12 then advance in registration out of the chemical application unit 54 and are merged at roller 56 with the top, or second plastic layer 18 and from there advances into the welding unit 58. The welding unit 58 is in exact registration with the chemical application unit 54 so that when a conventional heated dye comes down it creates a seam 16 that leaves a gap 24 between the seam 16 and the interior lotion layer 22. The heat seal also releaseably attaches the first or bottom layer 20 to the paper backing 12. The gap 24 insures that the lotion 22 does not interfere with the heat seam 16 and that only the precise amount of lotion 22 is applied inside the glove 10. This technique is also superior to the prior art technique of putting lotion into a glove after the glove is formed because it provides a much more uniform surface area with minimal waste. After the gloves 10 have been heat sealed, they advance out of the weld unit 58 and the excess 60 of the unusable web material 18 and 20 is removed. The paper web 12 between the gloves 10 is then cut or slit so that the remaining item 10 looks like the product shown in FIGS. 1A and 1B.

In use, an individual places his or her hand in opening 14 which in turn applies the lotion or medication 22 onto that person's hand. Gloves 10 can be made in right and left hand so as to permit the user to place his hand upside down or right or left in order to coat either the top or bottom of the hand.

FIG. 4 illustrates a method 100, similar to the method 50 shown in FIG. 3 for manufacturing a glove 10, by which a boot 30 is manufactured. According to method 100, the bottom web layer or film 20 passes through the electric shock station 52 which pre-treats the top surface of layer 20 to accept the lotion 42 applied at silkscreen chemical application unit 54. Bottom layer 20 merges with the paper carrier layer 12 at the roller 62 and advances into the silk screen chemical application unit 54 where a layer of lotion 42 is laid down in the shape of the boot 30 but having a periphery slightly smaller than the boot 30. The web then advances from the silk screen chemical application unit 54 and merges with the second or top film 18 at roller 56 and from there advances into the hot weld unit 58. A hot dye, in the form of boot 30, creates a hot melt seam 36 around the lotion or medication 54 but separated by a gap 44 therefrom so that no lotion or medication 42 gets into the hot melt seam 36. Clearly weld unit 58 has to keep in careful registration with the silk screen chemical application unit 54 so that the seam 36 is formed exactly over the lotion or medication area 42 but with sufficient room 44 to insure separation. The sandwich comprising back up paper 12, bottom film layer 20, lotion 42 and top layer 18 then advances out of the hot weld unit 18 where the excess plastic material 102, comprising the top and bottom film layers 18 and 20, respectively, is removed leaving just the boot 30 on the paper backer 12. The paper backing web 12 is then cut or sliced so as to leave an individual boot 30 on an individual piece of backing paper 32.

According to the preferred embodiment of the invention, the plastic film web 18 and 20 preferably comprises Polyethylene mixture with Metalazine, manufactured by Favorite Plastic in the U.S. and Interplastico in Mexico, but could also comprise 1) Polyethylene with Ethyl Malate mixture Acrolite or, 2) Non-woven fabric laminated to Polyethylene film. Likewise, the backing paper 12 comprises 50# white bleached paper 90 Bright, manufactured by International Paper Company, but could also comprise 40# or 60# paper. The lotion layers 22 and 42 could comprise any standard hand lotion, serum, or medication such as hand moisturizer, hand sanitizer, diabetic serum, or the like. The electric shock pre-treating station 52 is manufactured by J&K Company in West Germany. While an electroshock in the neighborhood of 90 dynes is preferable, the acceptable range is from 80 dynes to 95 dynes. The silk screen chemical application unit 54 is manufactured by Systematic Automation in Farmingdale, Conn., Model Number P101. Lastly, the hot weld unit 58 is Model 500S, manufactured by J&K Company in West Germany. While gloves 10 and boots 30 are described for use on human extremities, like hands or feet, it is possible that covers could be made for other parts of the body such as the ears, head (e.g. bonnet), face mask, etc.

While the invention has been described with reference to the preferred embodiment thereof, it will be appreciated by those of ordinary skill in the art and modifications can be made to the structure and method steps of the invention without department from the spirit and scope of the invention as a whole.

We claim:

1. A method for producing a cover for use on a human extremity, said cover having a liquid inner coating, said method comprising the steps of:
a. pre-treating a first web of material so that it will accept a liquid coating;
b. applying said liquid coating to a specific portion of said pre-treated first web;
c. bringing a second web of material into contact with said first web of plastic;
d. forming a seam in the shape of said human extremity cover and around said specific portion of said pre-treated first web wherein said seam does not come into contact with said liquid coating;
e. separating excess web material so that said cover is in the shape of said human extremity.

2. The method of claim 1 further comprising the step of:
f. bringing a third web of material into contact with one of said first or second webs of material and attaching said cover thereto so that said third web carries said cover after said excess web material is separated according to step e above.

3. The method of claim 2 wherein said pre-treating step (a) comprises the step of exposing said first web of material to an electrical shock.

4. The method of claim 3 wherein said applying step (b) comprises the step of applying said liquid coating by silk screening said liquid coating onto said pre-treated first web.

5. The method of claim 4 wherein said electrical shock is approximately in the range of 80 to 95 dynes.

6. The method of claim 5 wherein said step (d) of forming a seam is accomplished by heat welding.

7. The method of claim 6 wherein said weld is heated to approximately 290 degrees Centigrade.

8. The method of claim 7 wherein said third web of material comprises a paper backing web of material.

9. The method of claim 8 wherein said cover comprised a glove.

10. The method of claim 9 wherein said cover comprises a boot.

11. The method of claim 7 wherein said first and second webs of materials comprise a plastic material.

12. The method of claim 11 wherein said first web of material includes polyethylene.

13. The method of claim 7 wherein said first and second webs of materials comprise a non-woven fabric laminated to a plastic film.

14. The method of claim 13 wherein said plastic film includes polyethylene.

15. An apparatus for producing a cover for use on a part of the human body, said cover having a liquid inner liner, said apparatus comprising:
a first web feed means for providing a first web of material;
a second web feed means for feeding a second web of material;
lotion application means for applying a lotion or liquid material to a specific area of said second web;
seam forming means for forming a seam in the shape of said cover between said first and second webs,
wherein said cover includes an opening for said part of said human body and said seam is substantially spaced apart from said specific area of lotion or liquid material so that substantially none of said lotion or liquid material gets into said seam when said seam is formed.

16. The apparatus of claim 15 wherein said lotion application means comprises a silk screen machine.

17. The apparatus of claim 16 wherein said seam forming means comprised a hot die machine.

18. The apparatus of claim 17 further comprising:
a third web feed means for feeding a third web comprising a backing material to said first and second webs of material.

19. The apparatus of claim 18 further comprising:
web waste removing means for removing the excess portion of said first and second webs and leaving behind said cover attached to said backing material.

20. The apparatus of claim 19 wherein said first and second webs of material comprises a polyethylene or a polyethylene and cloth combination.

21. A cover for a human extremity comprising:
a first web of material;
a second web of material;
a seam connecting said first and second webs of material together an leaving room for the human extremity to be inserted in to said cover thought an opening;
an area of lotion or liquid applied to at least one of said two webs,
wherein said area of lotion or liquid application is located on the inside of said glove and separated by a gap from said seam.
